(19) United States
(12) Patent Application Publication
(10) Pub. No.: US 2024/0349336 A1
(43) Pub. Date: Oct. 17, 2024

(54) LOW LATENCY TRANSMISSION IN WIRELESS NETWORKS

(71) Applicant: Newracom, Inc., Irvine, CA (US)

(72) Inventor: Heejung Yu, Daejeon (KR)

(21) Appl. No.: 18/753,803

(22) Filed: Jun. 25, 2024

Related U.S. Application Data
(63) Continuation of application No. PCT/US22/81157, filed on Dec. 8, 2022.
(60) Provisional application No. 63/266,094, filed on Dec. 28, 2021.

(51) Int. Cl. H04W 74/0808

(52) U.S. Cl. CPC H04W 74/0808

(57) ABSTRACT

A method performed by a wireless device functioning as an access point (AP) in a wireless network to allow low latency transmission to the AP. The method includes wirelessly transmitting a trigger frame to a first station (STA) to provide a transmission opportunity (TXOP) to the first STA, wherein the trigger frame includes information indicating that a second STA other than the first STA is allowed to wirelessly transmit a data frame to the AP during the TXOP of the first STA.

### CROSS-REFERENCE TO RELATED APPLICATIONS

This application is a continuation of International Patent Application No. PCT/US2022/081157, filed Dec. 8, 2022, which claims the benefit of U.S. Provisional Patent Application No. 63/266,094, filed Dec. 28, 2021, titled, “Low latency transmission in IEEE 802.11be,” each of which is hereby incorporated by reference.

### TECHNICAL FIELD

The present disclosure generally relates to wireless communications, and more specifically, relates to low latency transmission in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many access points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

According to existing IEEE standards (e.g., IEEE 802.11ax), STAs are allowed to transmit data after sensing the channel according to distributed function coordination (DCF) rules. Even if a STA has emergency data that needs to be transmitted with short delay, the STA cannot transmit the emergency data if the wireless channel is occupied by another STA and the STA cannot acquire a channel access opportunity. Depending on the application area, however, the transmission of emergency data (e.g., latency sensitive data) may be an essential requirement.

FIG. 8 is a diagram showing a simple WLAN system that includes an AP 810, a first STA (STA1) 820, and a second STA (STA2) 830. FIG. 9 is a diagram showing a frame exchange sequence in the simple WLAN system according to existing IEEE 802.11 standards (e.g., IEEE 802.11ax). As shown in the diagram, the AP 810 may transmit a trigger frame 905 to provide a transmission opportunity (TXOP) for STA1 820. STA1 820 is considered to be the TXOP holder in this example. Upon receiving the trigger frame 905, STA1 820 may transmit a data frame 910 to the AP 810. Upon receiving the data frame 910, the AP 810 may transmit an acknowledgement (ACK) frame 915 to the AP 810 to confirm the reception of the data frame 910. The TXOP of STA1 820 may span the duration of the trigger frame 905, the data frame 910, and the ACK frame 915. STA2 may have emergency data to transmit to the AP 810 in the middle of the TXOP of STA1 820. With existing IEEE 802.11 standards, STA2 820 is not allowed to transmit data to the AP 810 until the TXOP of STA1 820 expires. Even after the TXOP of STA1 820 expires, STA2 820 has to compete with other STAs to acquire a channel access opportunity according to DCF rules. Thus, as shown in the diagram, STA2 820 may transmit a data frame 920 after the TXOP of STA1 820 expires at the earliest.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing a simple WLAN system that includes an AP, a first STA (STA1), and a second STA (STA2).

FIG. 9 is a diagram showing a frame exchange sequence in the simple WLAN system according to existing IEEE 802.11 standards (e.g., IEEE 802.11ax).

FIG. 10 is a diagram showing a frame exchange sequence for an overlaid low latency transmission (LLT) scheme, according to some embodiments.

FIG. 11 is a diagram showing a frame exchange sequence for a period-based LLT scheme with combined acknowledgement to both STAs, according to some embodiments.

FIG. 12 is a diagram showing a frame exchange sequence for a period-based LLT scheme with acknowledgement to each STA, according to some embodiments.

FIG. 13 is a diagram showing a frame exchange sequence for a period-based LLT scheme with acknowledgement for each frame, according to some embodiments.

FIG. 14 is a diagram showing a trigger frame format in IEEE 802.11ax.

FIG. 15 is a diagram showing a common info field format in a trigger frame in IEEE 802.11ax.

FIG. 16 is a diagram showing a user info list field format in a trigger frame in IEEE 802.11ax.

FIG. 17 is a diagram showing a table of trigger type field encoding in a trigger frame in IEEE 802.11ax.

FIG. 18 is a diagram showing a table of trigger type field encoding in a trigger frame, according to some embodiments.

FIG. 19 is a diagram showing an example of LLT_START_TIME and LLT_DURATION, according to some embodiments.

FIG. 20 is a diagram showing a period-based LLT scheme in a 80 MHz channel, according to some embodiments.

FIG. 21 is a flow diagram of a method for allowing low latency transmission, according to some embodiments.

FIG. 22 is a flow diagram of a method for performing low latency transmission, according to some embodiments.

### DETAILED DESCRIPTION

The present disclosure generally relates to wireless communications, and more specifically, relates to low latency transmission in a wireless network. As mentioned above, in existing Institute of Electrical and Electronics Engineers (IEEE) standards, if a STA has emergency data to transmit (such STA may be referred to as a low latency transmission (LLT) STA) to an access point (AP) in the middle of a transmission opportunity (TXOP) of another STA (referred to as the TXOP holder STA), the LLT STA is not allowed to transmit data to the AP until the TXOP of the TXOP holder STA expires. Even after the TXOP of the TXOP holder STA expires, the LLT STA has to compete with other STAs to acquire a channel access opportunity according to distributed coordination function (DCF) rules.

Embodiments are disclosed herein that allow emergency data to be transmitted even when the wireless channel is busy. In an embodiment, an AP wirelessly transmits a trigger frame to a first STA to provide a TXOP the first STA, wherein the trigger frame includes information indicating that a second STA other than the first STA is allowed to wirelessly transmit a data frame to the AP during the TXOP of the first STA. If the second STA receives the trigger frame, the second STA may wirelessly transmit a data frame to the AP during the TXOP of the first STA. Thus, embodiments allow the second STA to perform low latency transmission, where the second STA can transmit data to the AP during the TXOP of the first STA. The data frame may be transmitted using a period-based LLT scheme or a overlaid LLT scheme. With the period-based LLT scheme, the second STA is allowed to wirelessly transmit the data frame to the AP during one or more designated time periods within the TXOP of the first STA. With the overlaid LLT scheme, the second STA is allowed to wirelessly transmit the data frame to the AP while the first STA is wirelessly transmitting its own data frame to the AP. The trigger frame may be a new type of trigger frame that includes various information for facilitating low latency transmission. For example, for the period-based LLT scheme, the trigger frame may include information regarding the one or more designated time periods (e.g., when a time period starts and the duration of the time period). As another example, for the overlaid LLT scheme, the trigger frame may include information regarding a maximum allowed transmission power for the first STA and information regarding an allowed interference level at the AP. The second STA may determine a proper modulation coding scheme (MCS) (i.e., a transmission data rate) and/or transmission power level to use to wirelessly transmit the data frame based on information included in the trigger frame (such that the AP can properly receive the data frame even when there is interference from a wireless transmission by the first STA). Upon receiving the data frame from the second STA, the AP may provide an acknowledgement for the data frame using an acknowledgement scheme. Embodiments thus allow the second STA to transmit data to the AP even in the middle of the TXOP of the first STA. This allows the second STA to transmit emergency data to the AP with low latency without having to wait until the TXOP of the first STA expires.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

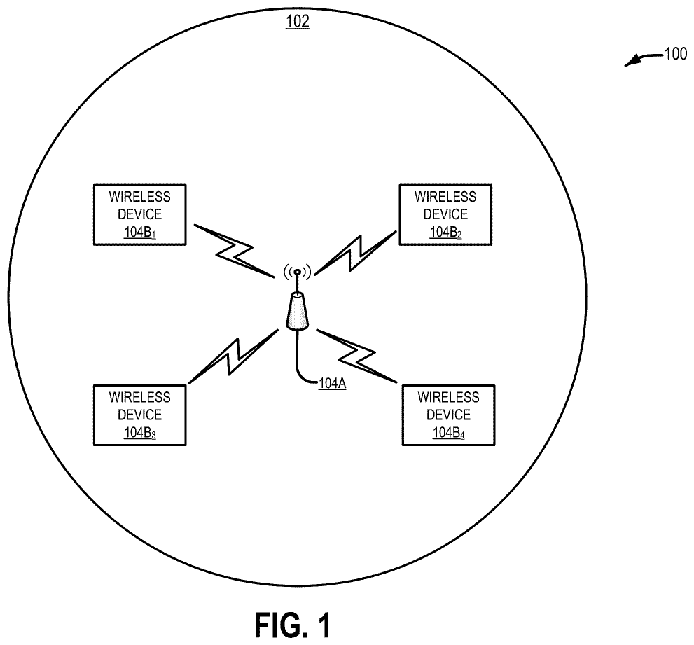

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for ease of description, only the non-AP STAs may be referred to as STAs. Although shown with four non-AP STAs (e.g., the wireless devices 104B1-104B4), the WLAN 100 may include any number of non-AP STAs (e.g., one or more wireless devices 104B).

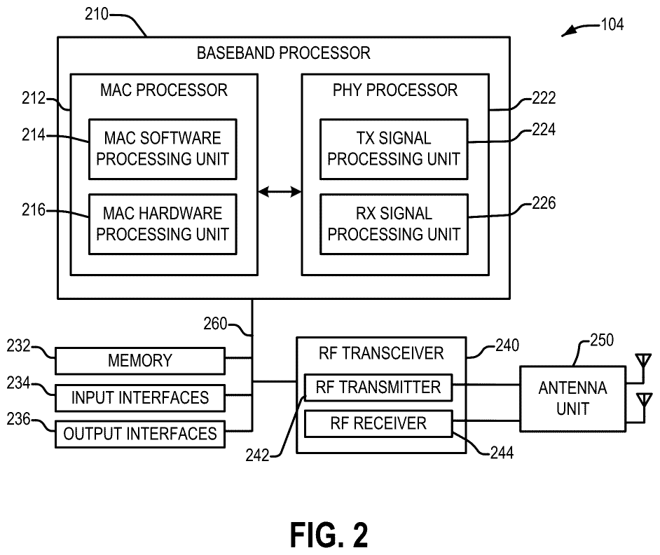

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory) 232, one or more input interfaces 234, and one or more output interfaces 236. The baseband processor 210, the storage device 232, the input interfaces 234, the output interfaces 236, and the RF (radio frequency) transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

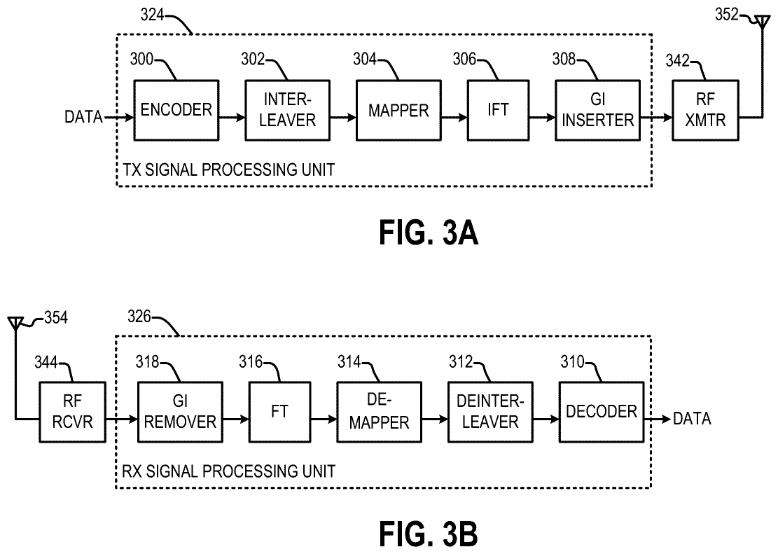

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

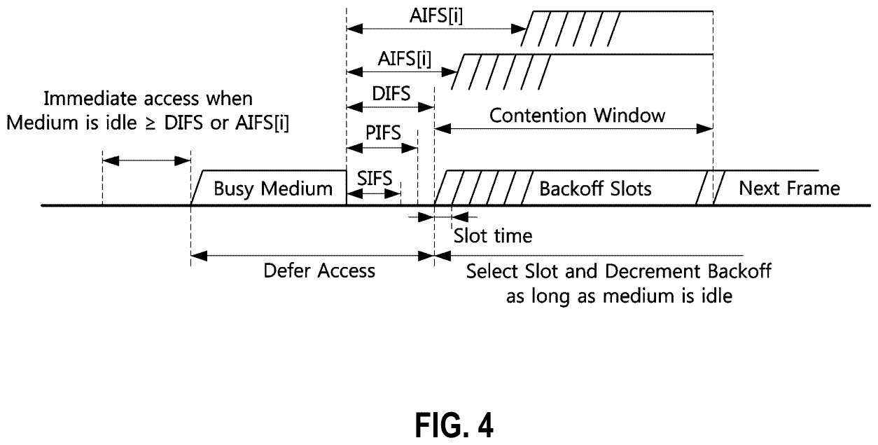

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QoS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

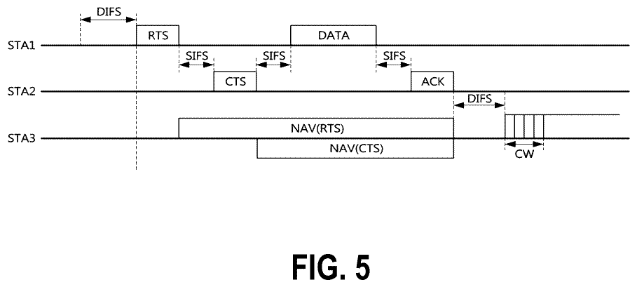

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

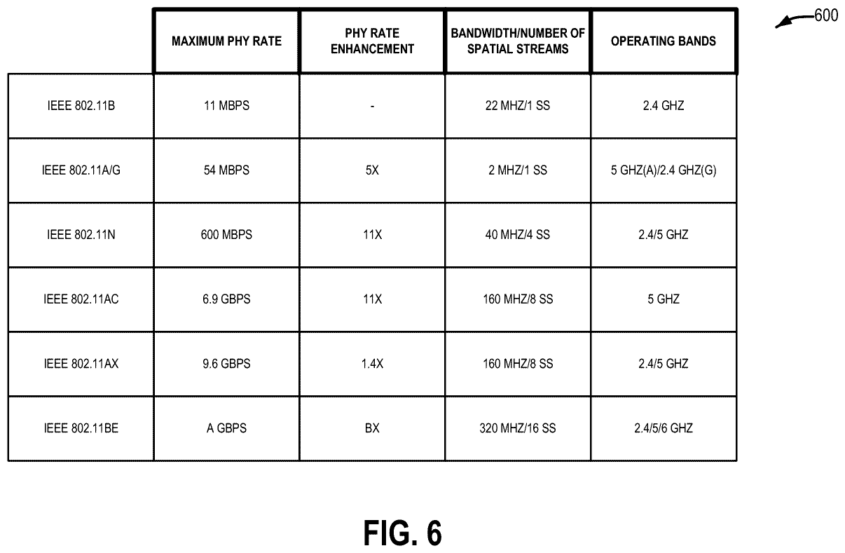

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz.) is being considered for unlicensed use. This would allow APs and STAs to become tri-band devices. Larger than 160 MHz data transmissions (e.g., 320 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

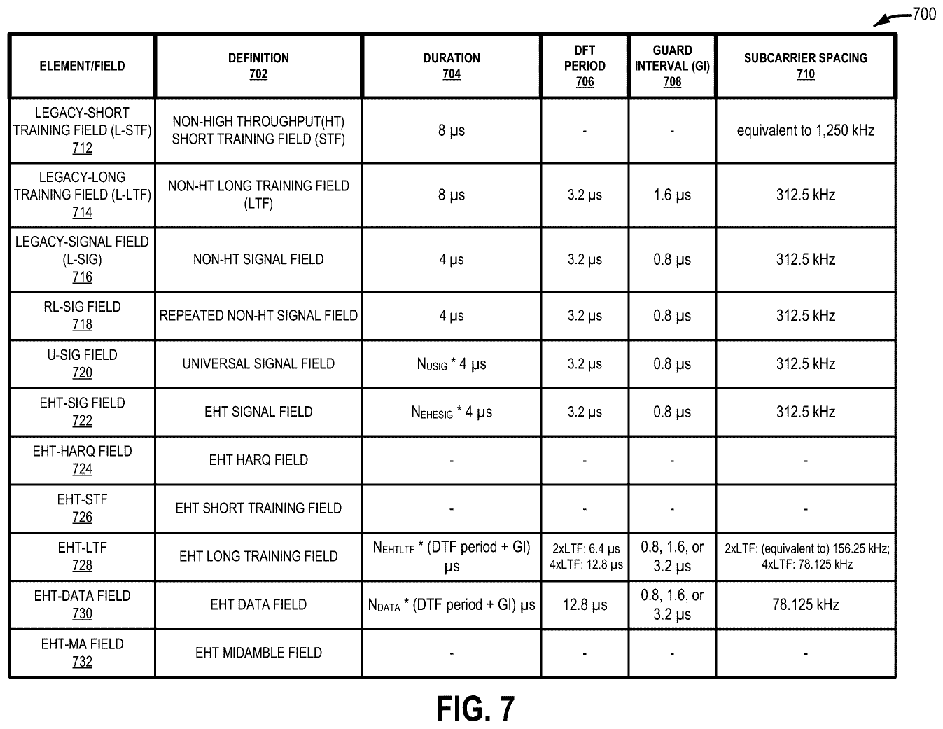

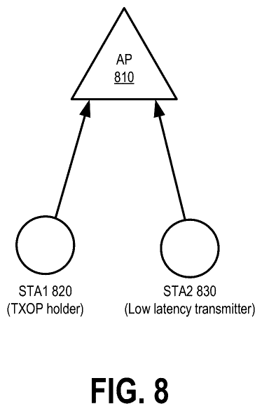

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a Table 700, which describes fields of an EHT frame format. In particular, Table 700 describes various fields that may be within the PHY preamble, data field, and midamble of an EHT frame format. For example, Table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HAPQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

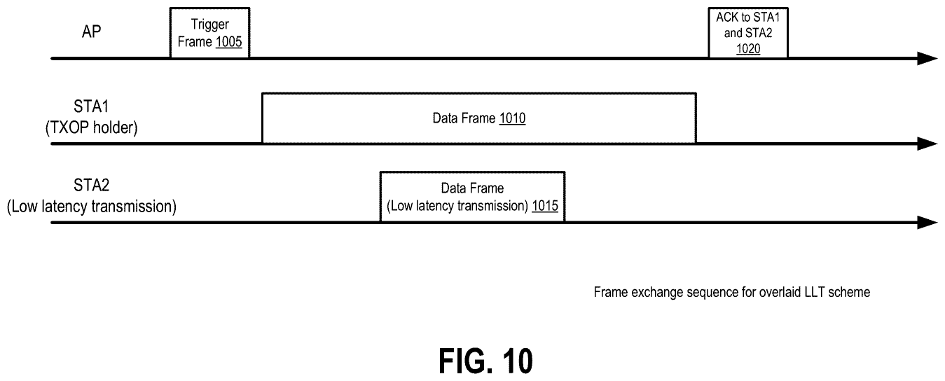

FIG. 10 is a diagram showing a frame exchange sequence for an overlaid LLT scheme, according to some embodiments. With the overlaid LLT scheme, a LLT STA is allowed to transmit data to an AP while the TXOP holder STA is transmitting data to the AP. As shown in the diagram, an AP may transmit a trigger frame 1005 to provide a TXOP to STA1. STA1 is the TXOP holder STA in this example. Upon receiving the trigger frame 1005, STA1 may transmit a data frame 1010 to the AP. STA2 may have data that it needs to transmit to the AP with low latency (e.g., emergency data). STA2 is a LLT STA in this example. STA2 may transmit a data frame 1015 to the AP while STA1 is transmitting its own data frame 1010 to the AP. STA2's data frame 1015 may be referred to as a LLT data frame. In this case, STA1's data frame 1010 and STA2's data frame 1015 co-exist and interfere with each other. Since the LLT data frame 1015 has higher priority, STA2 may transmit the LLT data frame 1015 to the AP such that the AP receives the LLT data frame 1015 with higher power compared to STA1's data frame 1010 so that the AP can decode the LLT data frame 1015 correctly. To this end, STA2 may control the MCS and transmission power that it uses to transmit the LLT data frame 1015 in a manner that considers the interference level caused by the two data frames at the AP side. To convey such information to STA1 and STA2, additional information can be included in the trigger frame 1005, as will be described in additional detail herein. When using the overlaid LLT scheme, STA1's data frame 1010 cannot be correctly received by the AP because of the LLT data frame 1015.

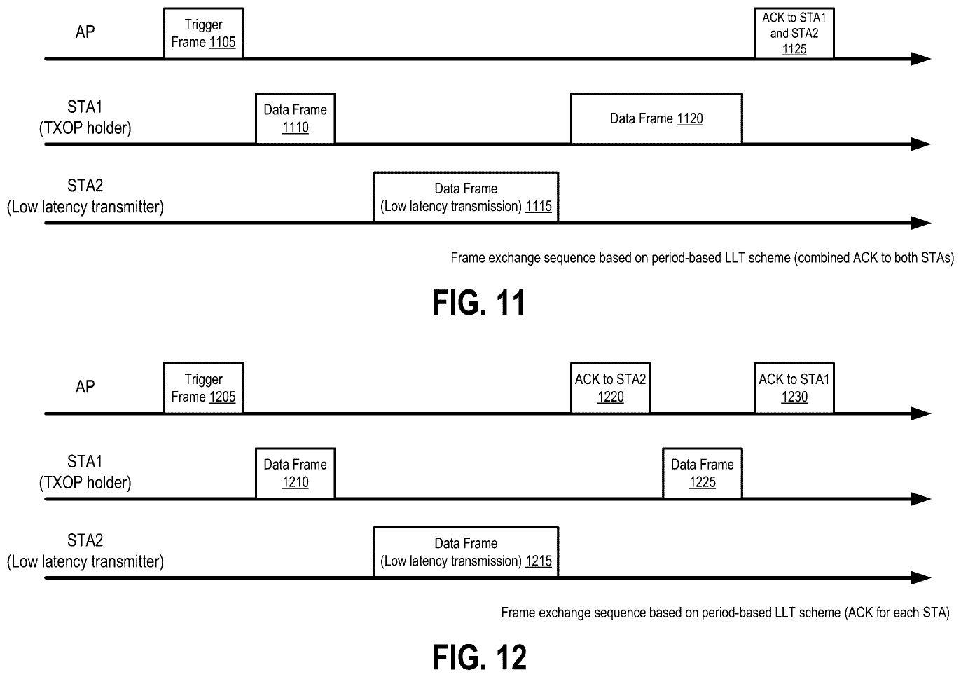

In an embodiment, to avoid this problem of the TXOP holder (e.g., STA1) not being able to transmit its data to the AP, a period-based LLT scheme can be used. The period-based LLT scheme provides a designated time period (also referred to as a LLT time period) during which a non-TXOP holder (e.g., STA2) is allowed to transmit data to the AP. In an embodiment, information regarding the designated time period is included in the trigger frame transmitted by the AP. In an embodiment, the TXOP holder can transmit its data frame during the designated time period if there is no LLT transmission at the beginning of the designated time period. Various acknowledgement schemes can be used with the period-based LLT scheme. Example acknowledgement schemes are shown in FIGS. 11-13.

FIG. 11 is a diagram showing a frame exchange sequence for a period-based LLT scheme with combined acknowledgement to both STAs, according to some embodiments. As shown in the diagram, an AP may transmit a trigger frame 1105 to provide a TXOP to STA1. STA1 is the TXOP holder STA. The trigger frame 1105 may include information regarding a designated time period (within the TXOP of STA1) during which STA2 is allowed to transmit data to the AP. Upon receiving the trigger frame 1005, STA1 may transmit a data frame 1110 to the AP. STA2 may then transmit a data frame 1115 (a LLT data frame) to the AP during the designated time period. STA2 is a LLT STA. STA1 may then transmit a data frame 1120 to the AP. The AP may then transmit an acknowledgement frame 1125 to STA1 and STA2 that provides acknowledgement for the data frames (data frame 1110, data frame 1120, and LLT data frame 1115). The acknowledgment for the data frames of STA1 (e.g., data frame 1110 and data frame 1120) may be a block acknowledgment which acknowledges both data frames.

FIG. 12 is a diagram showing a frame exchange sequence for a period-based LLT scheme with acknowledgement to each STA, according to some embodiments. As shown in the diagram, an AP may transmit a trigger frame 1205 to provide a TXOP to STA1. STA1 is the TXOP holder STA. The trigger frame 1105 may include information regarding a designated time period (within the TXOP of STA1) during which STA2 is allowed to transmit data to the AP. Upon receiving the trigger frame 1205, STA1 may transmit a data frame 1210 to the AP. STA2 may then transmit a data frame 1215 (a LLT data frame) to the AP during the designated time period. STA2 is a LLT STA. The AP may transmit an acknowledgement frame 1220 to STA2 that provides acknowledgement for the data frame 1215. STA1 may then transmit a data frame 1225 to the AP. The AP may then transmit an acknowledgement frame 1230 to STA1 that provides acknowledgement for the data frames transmitted by STA1 (data frame 1210 and data frame 1225). The acknowledgment (e.g., ACK to STA1 1230) for the data frames of STA1 may be a block acknowledgment which acknowledges both data frames (data frame 1210 and data frame 1225).

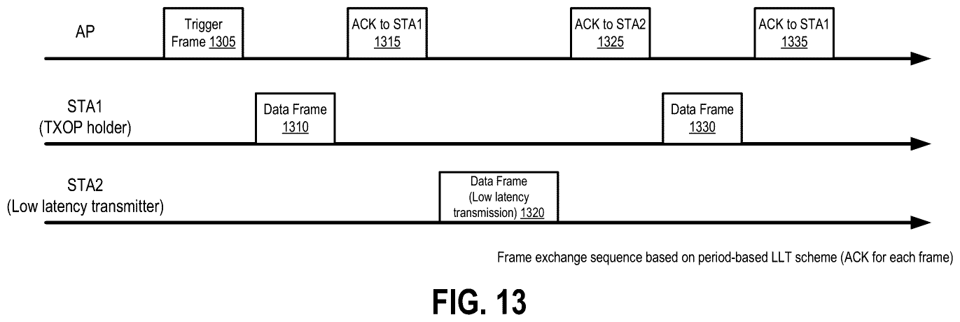

FIG. 13 is a diagram showing a frame exchange sequence for a period-based LLT scheme with acknowledgement for each frame, according to some embodiments. As shown in the diagram, an AP may transmit a trigger frame 1305 to provide a TXOP to STA1. STA1 is the TXOP holder STA. The trigger frame 1105 may include information regarding a designated time period (within the TXOP of STA1) during which STA2 is allowed to transmit data to the AP. Upon receiving the trigger frame 1305, STA1 may transmit a data frame 1310 to the AP. The AP may then transmit an acknowledgement frame 1315 to STA1 that provides acknowledgement for the data frame 1310. STA2 may then transmit a data frame 1320 (a LLT data frame) to the AP during the designated time period. STA2 is a LLT STA. The AP may then transmit an acknowledgement frame 1325 to STA2 that provides acknowledgement for the data frame 1320. STA1 may then transmit a data frame 1330 to the AP. The AP may then transmit an acknowledgement frame 1335 to STA1 that provides acknowledgement for the data frame 1330. In an embodiment, ACK to STA1 1315 can be omitted. In this case, ACK to STA1 1335 may be a block acknowledgment for both data frame 1310 and data frame 1330.

In FIGS. 11-13, an embodiment that provides a single designated time period within the TXOP of STA1 is provided for purpose of illustration. However, it will be appreciated that embodiments can be extended to provide multiple designated time periods.

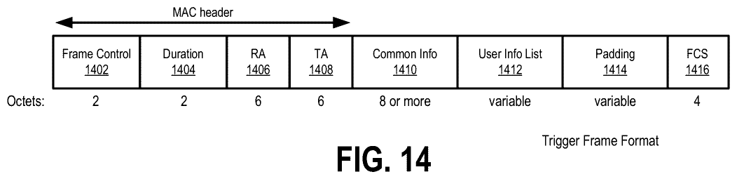

In an embodiment, a new type of trigger frame and operation scenarios may be defined to support low latency transmission. For context, the format of the existing trigger frame in IEEE standards (e.g., IEEE 802.11ax) is shown in FIGS. 14-16 and described in further detail below. For purposes of illustration, various embodiments are shown in the figures (e.g., FIGS. 14-16) and described herein using terminology/acronyms of IEEE 802.11 standards. However, it will be appreciated that embodiments are not necessarily limited to being used in a context that adopts such standards.

FIG. 14 is a diagram showing a trigger frame format in IEEE 802.11ax. As shown in the diagram, the trigger frame format includes a frame control field 1402, a duration field 1404, a RA (receiver address) field 1406, a TA (transmitter address) field 1408, a common info field 1410, a user info list field 1412, a padding field 1414, and an FCS (frame check sequence) field 1416.

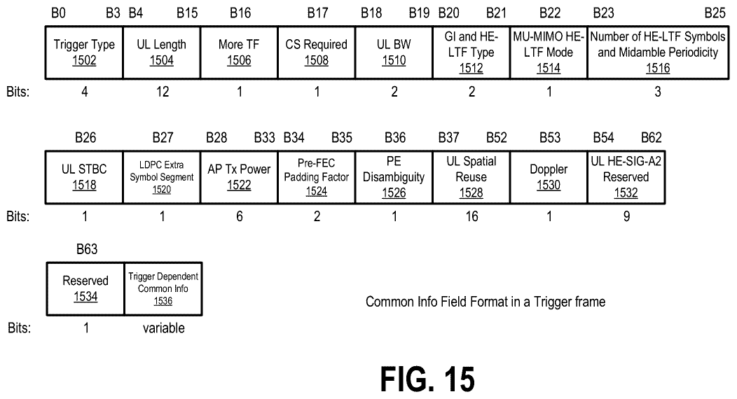

FIG. 15 is a diagram showing a common info field format in a trigger frame in IEEE 802.11ax. As shown in the diagram, the common info field format includes a trigger type field 1502, a UL length field 1504, a more TF field 1506, a CS required field 1508, a UL BW field 1510, a GI and HE-LTF type field 1512, a MU-MIMO HE-LTF mode field 1514, a number of HE-LTF symbols and midamble periodicity field 1516, a UL STBC field 1518, a LDPC extra symbol segment field 1520, an AP Tx power field 1522, a pre-FEC padding factor field 1524, a PE disambiguity field 1526, a UL spatial reuse field 1528, a doppler field 1530, a UL HE-SIG-A2 reserved field 1532, a reserved field 1534, and a trigger dependent common info field 1536.

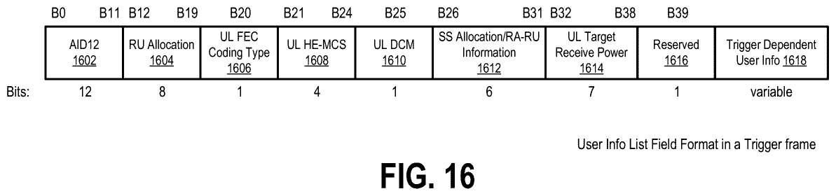

FIG. 16 is a diagram showing a user info list field format in a trigger frame in IEEE 802.11ax. As shown in the diagram, the user info list field format includes an AID12 field 1602, a RU allocation field 1604, a UL FEC coding type field 1606, a UL HE-MCS field 1608, a UL DCM field 1610, a SS allocation/RA-RU information field 1612, a UL target receive power field 1614, a reserved field 1616, and a trigger dependent user info field 1618.

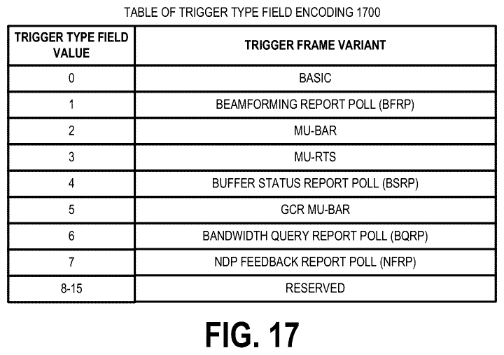

FIG. 17 is a diagram showing a table of trigger type field encoding in a trigger frame in IEEE 802.11ax. As shown in the diagram, the table 1700 includes a trigger type field value column and a trigger frame variant column. A trigger type field value of “0” indicates a basic trigger frame, a trigger type field value of “1” indicates a beamforming report poll (BFRP) trigger frame, trigger type field value of “2” indicates a MU-BAR (multi-user block ACK request) trigger frame, a trigger type field value of “3” indicates a MU-RTS (multi-user request to send) trigger frame, a trigger type field value of “4” indicates a buffer status report poll (BSRP) trigger frame, a trigger type field value of “5” indicates a GCR (group cast retries) MU-BAR trigger frame, a trigger type field value of “6” indicates a bandwidth query report poll (BQRP) trigger frame, a trigger type field value of “7” indicates a NDP (null data packet) feedback report poll (NFRP) trigger frame, and trigger type field values “8” to “15” are reserved.

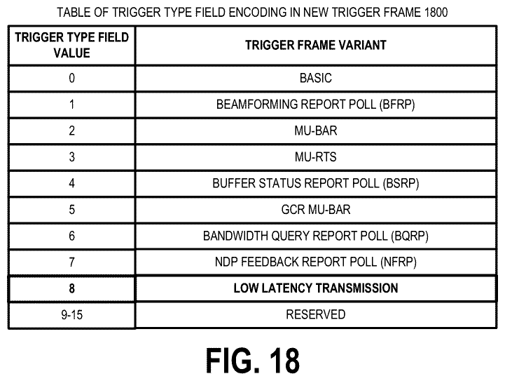

FIG. 18 is a diagram showing a table of trigger type field encoding in a trigger frame, according to some embodiments. A new type/variant of trigger frame may be defined to support low latency transmission. One of the reserved trigger type field values (e.g., 8-15) may be used to indicate the new trigger frame (referred to herein as a low latency transmission trigger frame). For example, the trigger type field value of “8” may be used to indicate a low latency transmission trigger frame as shown in the table 1800. The table 1800 shown in the diagram is similar to the table 1700 shown in FIG. 17 but indicates that the trigger type field value of “8” indicates a low latency transmission trigger frame (e.g., a trigger frame indicating that a STA other than the TXOP holder STA is allowed to transmit data during the TXOP of the TXOP holder STA). Although the example shown in the diagram uses the value of “8” to indicate a low latency transmission trigger frame, it will be appreciated that other values can be used for this purpose (e.g., any of the reserved values can be used).

A low latency transmission trigger frame may include various information that can be useful for supporting a low latency transmission. In an embodiment, the trigger dependent common info field and/or trigger dependent user info field of the trigger may include information that can be used for supporting low latency transmission.

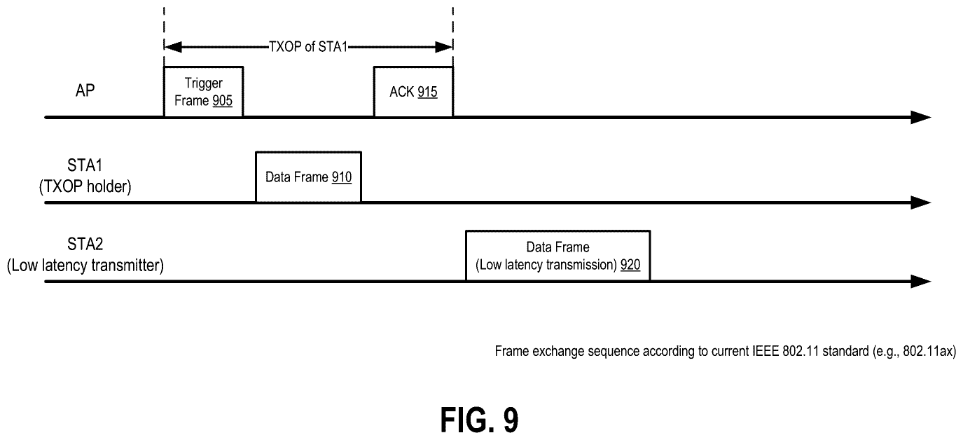

In an embodiment, for the overlaid LLT scheme, the trigger frame includes the following information: (1) IND_LLT: Indication to allow low latency transmission for emergency data; (2) LLT_ADDRESSS: Address of the potential STA which is allowed to transmit emergency data; (3) MAX_TX_PWR: Maximum transmission power for TXOP holders (e.g., STA1 shown in FIG. 9) (there can be multiple values for multiple TXOP holders); (4) INTF_LEVEL: Interference level at the AP (e.g., including a colored interference margin value) (there can be multiple values for multiple subchannels (e.g., OFDMA)).

In an embodiment, IND_LLT is indicated using a single bit. LLT_ADDRESS may be the address of a STA that is allowed to transmit LLT data. In an embodiment, LLT_ADDRESS is an association ID (AID) or its variant. In an embodiment, IND_LLT and INTF_LEVEL are included in the trigger dependent common info field of the common info field of the trigger frame. In an embodiment, if the STA indicated by LLT_ADDRESS does not transmit its emergency data, another STA that has emergency data to transmit can transmit its emergency data. In this case, a STA that is not indicated by LLT_ADDRESS may perform carrier sensing to sense the other low latency transmissions. In such case, the trigger frame may include information about CCA. The CCA information may inform STAs that are not indicated by LLT_ADDRESS to sense the channel based on preamble correlation.

In an embodiment, INTF_LEVEL is indicated using one byte (8 bits) of information representing the interference power in dB scale. The number of INTF_LEVEL values included in the trigger frame may depend on the UL BW field (e.g., B18 and B19 of the common info field) (the number of bits in the UL BW field can change depending on the maximum channel bandwidth and subchannel allocation in IEEE 802.11be). For example, if the UL BW field indicates that the uplink bandwidth is 80 MHx, four INTF_LEVEL values may be included in the trigger dependent common info field, one for each 20 MHz subchannel. When determining INTF_LEVEL, the effect of colored noise may be considered. Data OFDM symbols may become interference to the low latency transmission. Since data OFDM symbols of a TXOP holder's transmission is not white noise, additional interference margin can be included when determining INTF_LEVEL.

In an embodiment, MAX_TX_PWR is included in the trigger dependent user info field of the user info list field of the trigger fame. The AP may set MAX_TX_PWR to limit the amount of interference caused by signals from TXOP holders. In an embodiment, the AP estimates the pathloss between a TXOP holder (e.g., STA1 shown in FIG. 9) and the AP using a previous frame (e.g., a frame that was transmitted before the trigger frame). Then, the AP may calculate MAX_TX_PWR for the TXOP holder to make the interference level to be INTF_LEVEL.

In an embodiment, for a given INTF_LEVEL, the AP determines MAX_TX_PWR according to the following equation:

(MAX_TX_PWR for TXOP holder)=INTF_LEVEL+(Pathloss between AP and TXOP holder for a given subchannel), where (Pathloss between AP and TXOP holder) is estimated as (TXOP holder's Tx power)−(RCPI (receive channel power indicator) or RSSI (receive signal strength indication) of the previous frame transmitted by the TXOP holder to the AP).

In an embodiment, MAX_TX_PWR is different depending on the subchannel (or TXOP holder in OFDMA). For example, if the UL BW field indicates that the uplink bandwidth is 80 MHz. and each 20 MHz subchannel is allocated to four different STAs, a MAX_TX_PWR value for each 20 MHx subchannel may be included in the trigger dependent user info field.

The AP may generate a trigger frame that includes the above-mentioned information related to low latency transmission and transmit the trigger frame. After receiving the trigger frame, the TXOP holders (e.g., STA1 shown in FIG. 9) may transmit a data frame using a transmission power that is less than or equal to MAX_TX_PWR included in the trigger frame.

After receiving the trigger frame, the LLT STA (e.g., STA2 shown in FIG. 9) may transmit a data frame during the TXOP of the TXOP holder STA using a MCS (modulation coding scheme) based on INTF_LEVEL and LLT_TX_PWR. In an embodiment, LLT_TX_PWR is determined using the following equation:

LLT_TX_PWR=(required SNR (signal-to-noise ratio) for the selected MCS)+(INTF_LEVEL)+(pathloss between AP and LLT STA), where (pathloss between AP and LLT STA) can be estimated as (AP's Tx power of the trigger frame)−(RCPI or RSSI of the trigger frame transmitted by the AP).

In an embodiment, if the LLT data frame is transmitted in multiple 20 MHz subchannels, INTF_LEVEL may be a maximum value of the INTF_LEVEL values of the multiple subchannels.

In an embodiment, for the overlaid LLT scheme, the AP continues performing preamble detection during reception of the TXOP holder's data frame. The AP may need to receive LLT data frames with low SINR (signal-to-interference-plus-noise ratio) due to interference (e.g., caused by TXOP holder's signal). Thus, in an embodiment, to improve the preamble detection performance, the transmission power of the preamble of LLT data frames is boosted compared to other parts of the data frame (e.g., SIGNAL and data parts).

In an embodiment, for the period-based LLT scheme, the trigger frame includes the following information: (1) IND_LLT: Indication to allow low latency transmission for emergency data; (2) LLT_ADDRESSS: Address of the potential STA which is allowed to transmit emergency data; (3) LLT_START_TIME: the start time of a designated time period (also referred to as a LLT time period) during which a STA is allowed to transmit data (there can be multiple values for multiple subchannels (e.g., multiple 20 MHz subchannels)); (4) LLT_DURATION: duration of the designated time period (there can be multiple values for multiple subchannels).

In the period-based LLT scheme, multiple STAs may compete to acquire a channel access opportunity during the TXOP of the TXOP holder STA. Thus, in an embodiment LLT_ADDRESS may be omitted in the trigger frame. Any STA may transmit its emergency data during the designated time period after channel sensing.

In an embodiment, LLT_START_TIME is expressed in terms of the number of slots after the transmission of the trigger frame. In an embodiment, LLT_DURATION is expressed in terms of the number of a number of slots (e.g., starting from LLT_START_TIME).

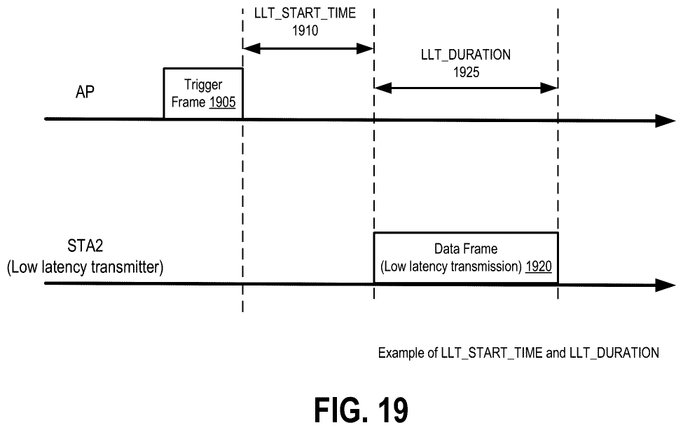

FIG. 19 is a diagram n showing an example of LLT_START_TIME and LLT_DURATION, according to some embodiments. As shown in the diagram, an AP may transmit a trigger frame 1905. The trigger frame 1905 may include LLT_START_TIME and LLT_DURATION. In an embodiment, LLT_START_TIME and/or LLT_DURATION are included in the trigger dependent common info field of the common info field of the trigger frame 1905. In an embodiment LLT_DURATION is optional (LLT_DURATION can be excluded from the trigger frame). After receiving the trigger frame 1905, STA2 may determine when the designated time period (LLT time period) begins and the duration of the designated time period based on LLT_START_TIME and LLT_DURATION. As shown in the diagram, STA2 may transmit data frame 1920 after waiting for LLT_START TIME 1910 after the trigger frame 1905 for a duration of LLT_DURATION 1925.

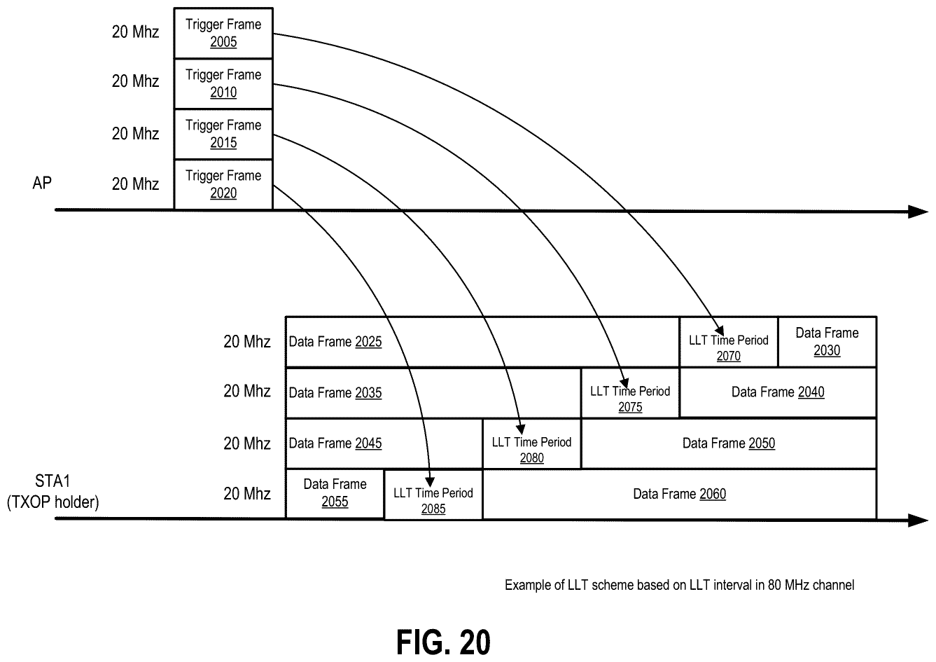

FIG. 20 is a diagram showing a period-based LLT scheme in a 80 MHz channel, according to some embodiments. As shown in the diagram, an AP may simultaneously transmit trigger frame 2005, trigger frame 2010, trigger frame 2015, and trigger frame 2020, each in a different 20 MHz subchannel. The trigger frames may be designed such that each 20 MHz subchannel is allocated a different time period for low latency transmission. For example, as shown in the diagram, trigger frame 2005 may allocate time period 2070 for low latency transmission, trigger frame 2010 may allocate time period 2075 for low latency transmission, trigger frame 2015 may allocate time period 2080 for low latency transmission, and trigger frame 2020 may allocate time period 2085 for low latency transmission. STA1 (the TXOP holder in this example) may transmit data frames to the AP using the respective subchannels except during the time periods allocated to the subchannel for low latency transmission (although in some embodiments STA1 may transmit data frames to the AP even during a time period allocated for low latency transmission if there are no LLT transmissions at the beginning of the time period). For example, as shown in the diagram, STA1 may transmit data frame 2025 and data frame 2030 using a first 20 MHz subchannel, transmit data frame 2035 and data frame 2040 using a second 20 MHz subchannel, transmit data frame 2045 and data frame 2050 using a third 20 MHz subchannel, and transmit data frame 2055 and data frame 2060 using a fourth 20 MHz subchannel. STAs other than STA1 may transmit emergency data during one or more of the time periods allocated for low latency transmission depending on the available subchannel. In the example shown in the diagram, the time periods for low latency transmission are staggered and non-overlapping. However, it will be appreciated that other configurations of time periods can be used.

For purposes of illustration, embodiments have been described in scenarios where there is a single TXOP holder (e.g., STA1 shown in FIGS. 10-13). However, it will be appreciated that multiple TXOP holders can be considered in multi-user transmission schemes (e.g., MU-MIMO and OFDMA cases). That is, embodiments can be used in multi-user scenarios.

A technological advantage of embodiments disclosed herein is that they provide a low latency transmission scheme that allows STAs to transmit data (e.g., emergency latency sensitive data) to an AP during the TXOP of another STA. By using the low latency transmission scheme disclosed herein, emergency data can be transmitted with negligible or guaranteed transmission delay.

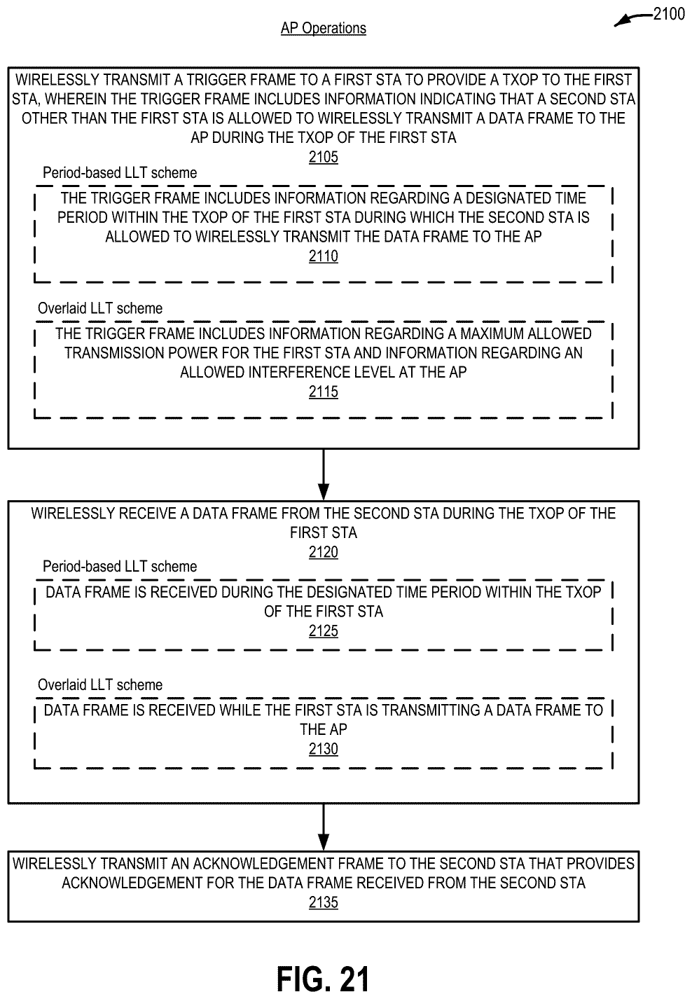

Turning now to FIG. 21, a method 2100 will be described for allowing low latency transmission, in accordance with an example embodiment. The method 2100 may be performed by one or more devices described herein. For example, the method 2100 may be performed by a wireless device 104 functioning as an AP in a wireless network.

Additionally, although shown in a particular order, in some embodiments the operations of the method 2100 (and the other methods shown in the other figures) may be performed in a different order. For example, although the operations of the method 2100 are shown in a sequential order, some of the operations may be performed in partially or entirely overlapping time periods.

As shown in FIG. 21, the method 2100 may commence at operation 2105 with an AP wirelessly transmitting a trigger frame to a first STA to provide a TXOP to the first STA, wherein the trigger frame includes information indicating that a second STA other than the first STA is allowed to wirelessly transmit a data frame to the AP during the TXOP of the first STA. In an embodiment, the trigger frame includes a common information field, wherein the common information field includes a trigger type field, wherein the trigger type field includes a value indicating that the trigger frame is a low latency transmission type trigger frame (e.g., value of “8” in the trigger type field).

In an embodiment, as shown in block 2110, if a period-based LLT scheme is being used, the trigger frame includes information regarding a designated time period within the TXOP of the first STA during which the second STA is allowed to wirelessly transmit the data frame to the AP. In an embodiment, the information regarding the designated time period includes information regarding a start time of the designated time period. In an embodiment, the information regarding the start time of the designated time period is expressed in terms of a number of slots after transmission of the trigger frame. In an embodiment, the information regarding the designated time period further includes information regarding a duration of the designated time period. In an embodiment, the information regarding the duration of the designated time period is expressed in terms of a number of slots. In an embodiment, the trigger frame includes a common information field, wherein the common information field includes a trigger dependent common information field that includes the information regarding the designated time period. In an embodiment, the trigger frame further includes information regarding an address of the second STA.

In an embodiment, the trigger frame is wirelessly transmitted simultaneously with one or more additional trigger frames, wherein the trigger frame and the one or more additional trigger frames are transmitted in different subchannels and indicate different non-overlapping designated time periods during which STAs other than the first STA are allowed to wirelessly transmit data frames to the AP.

In an embodiment, as shown in block 2115, if an overlaid LLT scheme is being used, the trigger frame includes information regarding a maximum allowed transmission power for the first STA and information regarding an allowed interference level at the AP. In an embodiment, the maximum allowed transmission power for the first STA is determined based on the allowed interference level at the AP and a pathloss between the AP and the first STA for a given subchannel. In an embodiment, the pathloss between the AP and the first STA for the given subchannel is determined based on a transmission power previously used by the first STA to wirelessly transmit a previous frame to the AP and a receive power level (e.g., RCPI or RSSI) of the previous frame at the AP.

At operation 2120, the AP wirelessly receives a data frame from the second STA during the TXOP of the first STA.

In an embodiment, as shown in block 2125, if a period-based LLT scheme is being used, the data frame is received during the designated time period within the TXOP of the first STA. In an embodiment, the AP wirelessly receives a data frame (that is different from the data frame transmitted by the second STA) from the first STA during one or more time periods within the TXOP of the first STA that are outside of the designated time period.

In an embodiment, as shown in block 2115, if an overlaid LLT scheme is being used, the data frame is received while the first STA is transmitting a data frame to the AP. In an embodiment, the second STA wirelessly transmits the data frame using a MCS and using a transmission power level, wherein the second STA determines the transmission power level based on a SNR for the MCS, the allowed interference level at the AP, and a pathloss between the AP and the second STA for a given subchannel. In an embodiment, the second STA determines the pathloss between the AP and the second STA for the given subchannel based on a transmission power used by the AP to wirelessly transmit the trigger frame and a receive power level (e.g., RCPI or RSSI) of the trigger frame at the second STA.

At operation 2135, the AP wirelessly transmits an acknowledgement frame to the second STA that provides acknowledgement for the data frame received from the second STA. In an embodiment, the (single) acknowledgement frame provides acknowledgement for both the data frame transmitted by the first STA and the data frame transmitted by the second STA.

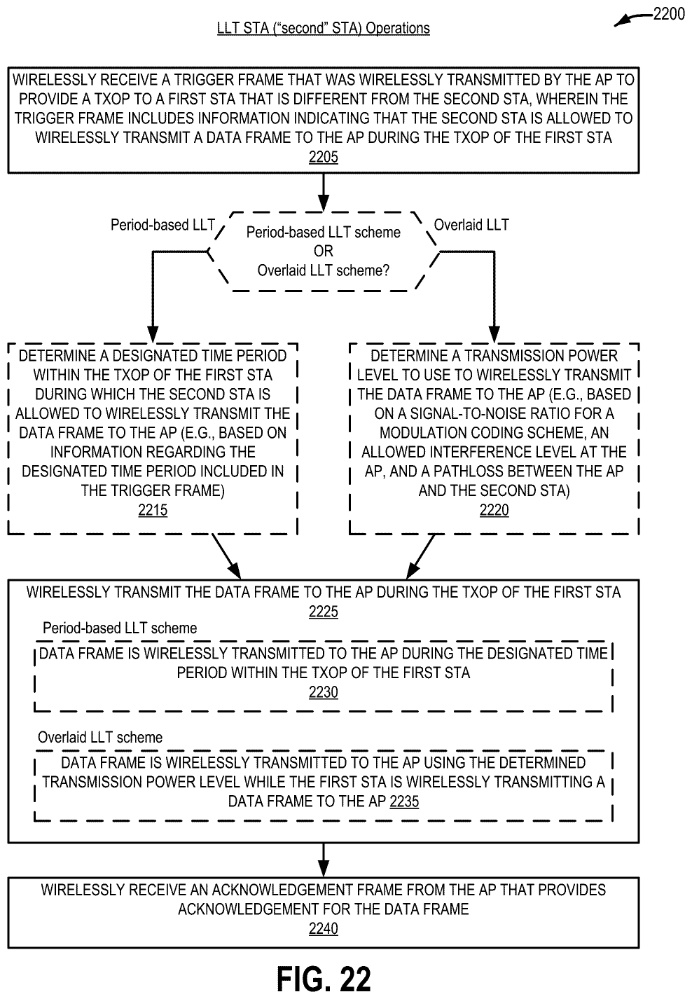

Turning now to FIG. 22, a method 2200 will be described for performing low latency transmission, in accordance with an example embodiment. The method 2200 may be performed by one or more devices described herein. For example, the method 2200 may be performed by a wireless device 104 functioning as a (non-AP) STA in a wireless network. This STA may be a LLT STA and may be referred to in this example as the “second” STA (to distinguish from the TXOP holder STA, which is referred to in this example as the “first” STA).

As shown in FIG. 22, the method 2200 may commence at operation 2205 with the second STA wirelessly receiving a trigger frame that was wirelessly transmitted by the AP to provide a TXOP to a first STA that is different from the second STA, wherein the trigger frame includes information indicating that the second STA is allowed to wirelessly transmit a data frame to the AP during the TXOP of the first STA. In an embodiment, the trigger frame includes a common information field, wherein the common information field includes a trigger type field, wherein the trigger type field includes a value indicating that the trigger frame is a low latency transmission type trigger frame (e.g., value of “8” in the trigger type field).

In an embodiment, if a period-based LLT scheme is being used, at operation 2215, the second STA determines a designated time period within the TXOP of the first STA during which the second STA is allowed to wirelessly transmit the data frame to the AP. In an embodiment, the second STA determines the designated time period based on information regarding the designated time period included in the trigger frame. Otherwise, if an overlaid LLT scheme is being used, at operation 2220, the second STA determines a transmission power level to use to wirelessly transmit the data frame to the AP. In an embodiment, the second STA determines the transmission power level to use to wirelessly transmit the data frame to the AP based on a SNR for a MCS, an allowed interference level at the AP, and a pathloss between the AP and the second STA for a given subchannel, wherein the trigger frame includes information regarding the allowed interference level at the AP. In an embodiment, the pathloss between the AP and the second STA for the given subchannel is determined based on a transmission power used by the AP to wirelessly transmit the trigger frame and a receive power level of the trigger frame at the second STA.

At operation 2225, the second STA wirelessly transmits the data frame to the AP during the TXOP of the first STA. In an embodiment, a preamble of the data frame is wirelessly transmitted using a higher transmission power compared to other parts of the data frame.

In an embodiment, as shown in block 2230, if a period-based LLT scheme is being used, the data frame is wirelessly transmitted to the AP during the designated time period within the TXOP of the first STA.

In an embodiment, as shown in block 2235, if an overlaid LLT scheme is being used, the data frame is wirelessly transmitted to the AP using the determined transmission power level while the first STA is wirelessly transmitting a data frame to the AP.

At operation 2240, the second STA wirelessly receives an acknowledgement frame from the AP that provides acknowledgement for the data frame.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device functioning as an access point (AP) to allow low latency transmission to the AP, the method comprising:
wirelessly transmitting a trigger frame to a first station (STA) to provide a transmission opportunity (TXOP) to the first STA, wherein the trigger frame includes information indicating that a second STA other than the first STA is allowed to wirelessly transmit a data frame to the AP during the TXOP of the first STA.

2. The method of claim 1, wherein the second STA is allowed to wirelessly transmit the data frame to the AP during a designated time period within the TXOP of the first STA.

3. The method of claim 2, wherein the trigger frame further includes information regarding the designated time period.

4. The method of claim 3, wherein the information regarding the designated time period includes information regarding a start time of the designated time period.

5. The method of claim 4, wherein the information regarding the start time of the designated time period is expressed in terms of a number of slots after transmission of the trigger frame.

6. The method of claim 4, wherein the information regarding the designated time period further includes information regarding a duration of the designated time period.

7. The method of claim 6, wherein the information regarding the duration of the designated time period is expressed in terms of a number of slots.

8. The method of claim 3, wherein the trigger frame includes a common information field, wherein the common information field includes a trigger dependent common information field that includes the information regarding the designated time period.

9. The method of claim 3, wherein the trigger frame further includes information regarding an address of the second STA.

10. The method of claim 2, wherein the trigger frame is wirelessly transmitted simultaneously with one or more additional trigger frames, wherein the trigger frame and the one or more additional trigger frames are transmitted in different subchannels and indicate different non-overlapping designated time periods during which STAs other than the first STA are allowed to wirelessly transmit data frames to the AP.

11. The method of claim 2, further comprising:
wirelessly receiving a first data frame from the first STA during one or more time periods within the TXOP of the first STA that are outside of the designated time period; and
wirelessly receiving the data frame, which is a second data frame different from the first data frame, from the second STA during the designated time period.

12. The method of claim 11, further comprising:
wirelessly transmitting a single acknowledgement frame that provides acknowledgement for both the first data frame and the second data frame.

13. The method of claim 1, wherein the second STA is allowed to wirelessly transmit the data frame to the AP during the TXOP of the first STA while the first STA is wirelessly transmitting a data frame to the AP.

14. The method of claim 13, wherein the trigger frame further includes information regarding a maximum allowed transmission power for the first STA and information regarding an allowed interference level at the AP.

15. The method of claim 14, wherein the maximum allowed transmission power for the first STA is determined based on the allowed interference level at the AP and a pathloss between the AP and the first STA for a given subchannel.

16. The method of claim 15, wherein the pathloss between the AP and the first STA for the given subchannel is determined based on a transmission power previously used by the first STA to wirelessly transmit a previous frame to the AP and a receive power level of the previous frame at the AP.

17. The method of claim 14, further comprising:
wirelessly receiving the data frame from the second STA during the TXOP of the first STA.

18. The method of claim 17, wherein the second STA wirelessly transmits the data frame using a modulation and coding scheme (MCS) and using a transmission power level, wherein the second STA determines the transmission power level based on a signal-to-noise ratio (SNR) for the MCS, the allowed interference level at the AP, and a pathloss between the AP and the second STA for a given subchannel.

19. The method of claim 18, wherein the second STA determines the pathloss between the AP and the second STA for the given subchannel based on a transmission power used by the AP to wirelessly transmit the trigger frame and a receive power level of the trigger frame at the second STA.

20. The method of claim 17, further comprising:
wirelessly transmitting an acknowledgement frame to the second STA that provides acknowledgement for the data frame.

21. The method of claim 1, wherein the trigger frame includes a common information field, wherein the common information field includes a trigger type field, wherein the trigger type field includes a value indicating that the trigger frame is a low latency transmission type trigger frame.

22. A method performed by a wireless device functioning as a second station (STA) to transmit a data frame to an access point (AP) during a transmission opportunity (TXOP) of a first STA that is different from the second STA, the method comprising:
wirelessly receiving a trigger frame that was wirelessly transmitted by the AP to provide the TXOP to the first STA, wherein the trigger frame includes information indicating that the second STA is allowed to wirelessly transmit the data frame to the AP during the TXOP of the first STA; and
wirelessly transmitting the data frame to the AP during the TXOP of the first STA after wirelessly receiving the trigger frame.

23. The method of claim 22, wherein the data frame is wirelessly transmitted to the AP during a designated time period within the TXOP of the first STA.

24. The method of claim 23, further comprising:
determining the designated time period based on information regarding the designated time period included in the trigger frame.

25. The method of claim 22, wherein the data frame is wirelessly transmitted to the AP simultaneously with a data frame wirelessly transmitted by the first STA.

26. The method of claim 25, further comprising:
determining a transmission power level to use to wirelessly transmit the data frame to the AP based on a signal-to-noise ratio (SNR) for a modulation coding scheme (MCS), an allowed interference level at the AP, and a pathloss between the AP and the second STA for a given subchannel, wherein the trigger frame includes information regarding the allowed interference level at the AP.

27. The method of claim 26, wherein the pathloss between the AP and the second STA for the given subchannel is determined based on a transmission power used by the AP to wirelessly transmit the trigger frame and a receive power level of the trigger frame at the second STA.

28. The method of claim 26, wherein a preamble of the data frame is wirelessly transmitted using a higher transmission power compared to other parts of the data frame.

29. The method of claim 22, wherein the trigger frame includes a common information field, wherein the common information field includes a trigger type field, wherein the trigger type field includes a value indicating that the trigger frame is a low latency transmission type trigger frame.

30. A wireless device to function as an access point (AP) in a wireless network that allows low latency transmission to the AP, the wireless device comprising:
a radio frequency transceiver;
a memory device storing a set of instructions; and
a processor coupled to the memory device, wherein the set of instructions when executed by the processor causes the AP to:
wirelessly transmit, using the radio frequency transceiver, a trigger frame to a first station (STA) to provide a transmission opportunity (TXOP) to the first STA, wherein the trigger frame includes information indicating that a second STA other than the first STA is allowed to wirelessly transmit a data frame to the AP during the TXOP of the first STA.

31. A wireless device to function as a second station (STA) in a wireless network that is able to transmit a data frame to an access point (AP) during a transmission opportunity (TXOP) of a first STA that is different from the second STA, the wireless device comprising:
a radio frequency transceiver;
a memory device storing a set of instructions; and
a processor coupled to the memory device, wherein the set of instructions when executed by the processor causes the AP to:
wirelessly receive, via the radio frequency transceiver, a trigger frame that was wirelessly transmitted by the AP to provide the TXOP to the first STA, wherein the trigger frame includes information indicating that the second STA is allowed to wirelessly transmit the data frame to the AP during the TXOP of the first STA and
wirelessly transmit, via the radio frequency transceiver, the data frame to the AP during the TXOP of the first STA after wirelessly receiving the trigger frame.
